(19) United States
(12) Patent Application Publication
(10) Pub. No.: US 2008/0071797 A1
(43) Pub. Date: Mar. 20, 2008

(54) System and method to calculate average link growth on search engines for a keyword

(76) Inventor: Nathaniel L. Thornton, Spotsylvania, VA (US)

Correspondence Address: TY UNG, 16830 VENTURA BLVD., SUITE 360, ENCINO, CA, 91436, US

(21) Appl. No.: 11/901,203

(22) Filed: Sep. 14, 2007

Related U.S. Application Data
(60) Provisional application No. 60/844,617, filed on Sep. 15, 2006.

(51) Int. Cl. G06F 17/30

(52) U.S. Cl. 707/10; 707/E17.108

(57) ABSTRACT

The present invention relates to a system and method for determining the rate that domains, or web pages, build links in an industry over a set period of time based on a search term. The rate of links that domains acquire is determined by obtaining elements, or the number of links a domain has over a given period of time and dividing the number of links by the age of the domain. The average link growth on a search engine is determined by finding the median of all domains that returned an element based on the search term, or keyword searched.

### CROSS-REFERENCE TO RELATED APPLICATION

This application claims priority to provisional application No. 60/844617 filed on Sep. 15, 2006.

### FEDERALLY SPONSORED RESEARCH

Not Applicable

### SEQUENCE LISTING OR PROGRAM

Not Applicable

### FIELD OF THE INVENTION

The present invention relates to a system and method for determining the rate that domains or web pages build links in an industry and more particularly to the rate of links that domains or web pages acquire over a set period of time. This rate of links allows a domain to rank in the top results of search engines like Google, Yahoo, & MSN for a keyword.

Currently search engines like Google, Yahoo, and MSN uses links to a domain along with other data to calculate a domain's or web page's popularity. The calculation performed by these search engines determines the ranking of the domain or web page whenever a keyword is searched on these search engines.

Furthermore, because webmasters and online businesses have no way of correctly calculating the proper amount of links that has built over a given time period, a determination of the average link growth of a domain is vital. Current tools only offer the webmaster the option to view the number of links a domain has and not the industry average. As the number of links is vital to the ranking of a domain on a search engine, not knowing the industry average for the number of links to a domain based on a keyword limits the webmaster's or business' ability to rank high on a search engine when a keyword is searched. Thus, if a webmaster does not know the average link growth over a set period of time for the keyword, the webmaster will not know that they are overbuilding or underbuilding links. This can cause their websites to rank low in search results for a keyword or not be listed if they build too many or too little links.

### SUMMARY

The present invention relates to a system and method for determining the rate that domains or web pages build links in an industry and more particularly to the rate of links that domains or web pages obtain over a set period of time. The rate of links that domains or web pages obtain over a period of time is determined by obtaining elements, or the number of links a domain has over a given period of time and dividing the number of links by the age of the domain. The average link growth on a search engine is determined by finding the median of the results that returned an element based on the search term, or keyword searched.

### BRIEF DESCRIPTION OF THE FIGURES

FIG. 1 is a diagram of the system and method of the present invention.

FIG. 2 is a detailed diagram of the results step of the present invention.

FIG. 3 is a detailed diagram of the calculation step of the present invention.

### FIGURES—REFERENCE NUMERALS

100 . . . Search Term Request
101 . . . Data Source
102 . . . Results from Data Source
103 . . . Process of Domain from Results from Data Source
104 . . . Retrieval of Link Count for each Domain from Results from Data Source
105 . . . Retrieval of Create Date for each Domain from Results from Data Source
106 . . . Repeat Processing for each Domain from Results from Data Source
107 . . . Check if each Domain has a Link Count and Create Date
109 . . . Calculation
110 . . . Age calculation for each remaining Domain
111 . . . Elements calculation for each remaining Domain
112 . . . Repeat Calculation for each remaining Domain
113 . . . Count of Elements
114 . . . Determination of whether the number of element is odd or even
115 . . . Calculation of Median if number of element is odd
116 . . . Calculation of Median if number of element is even
117 . . . Return Calculated Median to User

### DETAILED DESCRIPTION

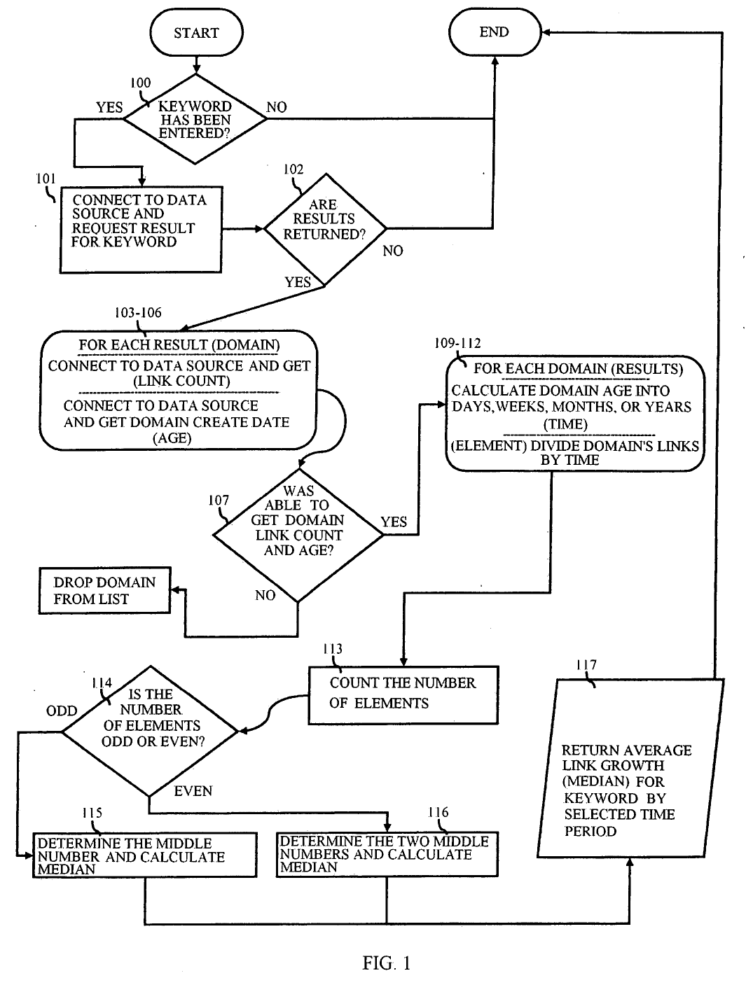

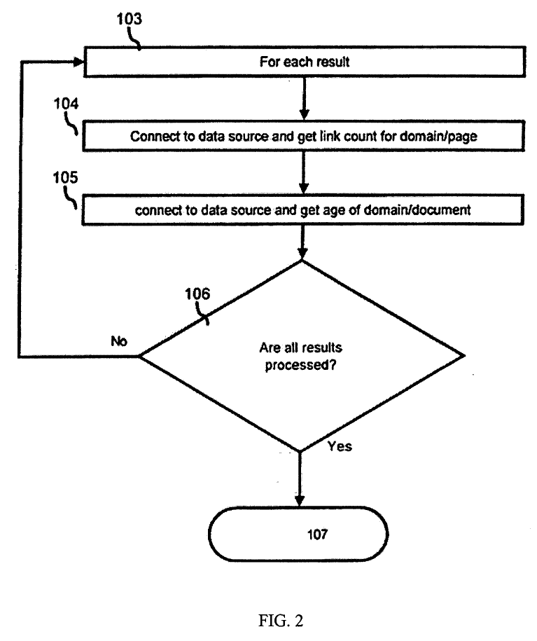

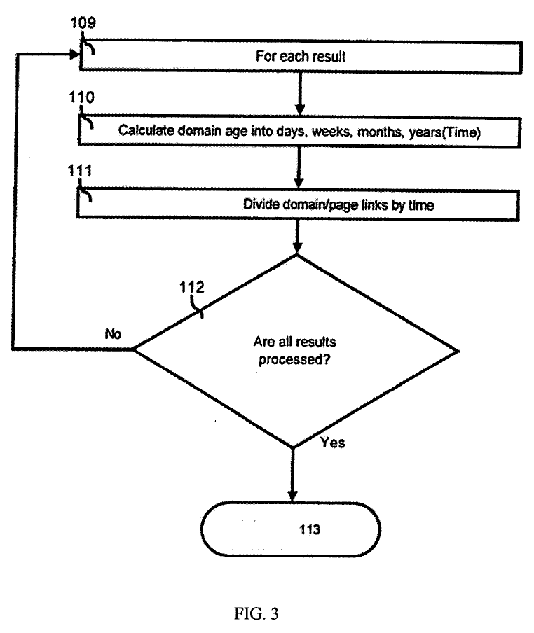

Referring to FIGS. 1 through 3, a detailed description of the present invention will be discussed. FIG. 1 is a detailed flow chart of the system and method to calculate average link growth of search engines for a search term, wherein the search term may be a keyword, of the present invention. Search term request 100 requires that the search term to be searched is entered. If no search term is entered in search term request 100, the program terminates. If a search term is entered in search term request 100, the process connects to a data source 101.

Data source 101 may be a web search engine such as Google, Yahoo, AOL, MSN, etc. Data source 101 process the requests from search term request 100 and returns results 102, a list of domain or websites that contains the search term entered in search term request 100. A check of returned results 102, or list of domains or websites with the search term requested, is performed to determine whether the data source 101 returned any results 102 for the search term entered in search term request 100. If no result 102 is returned, the program terminates and returns back to the search term request 100 step. If results 102 are returned, the process obtains additional information about each domain listed in results 102.

Processing step 103 takes the domains returned in results 102 and obtains link count 104 and create date 105. A link count 104 is obtained for each domain in results 102 returned by connecting back to the data source 101 previously used or another data source. The link count 104 is the number of links that are connected to each domain in results 102. Additionally, a second data source such as ICANN, Alexa, Archive.org is used to obtain the create date 105, or date that the domain was registered, for each domain in result 102. The process is repeated 106 until the link count 104 and create date 105 is obtained for each domain in results 102. A check 107 is performed to determine whether each domain in results 102 has a link count 104 and create date 105. Any domain that does not have either a link count 104 or create date 105 or both is removed from the results 102 list.

For domain in results 102 that has both a link count 104 and create date 105, calculations are made. In calculation 109, the age 110 of the remaining domain in results 102 is determined by subtracting the create date 105 for each domain from the current date. A calculation to determine elements 111, or average amount of links a domain has acquired over the lifetime of the domain, is determined by dividing the link count 104 of each domain by the age 110 of the domain.

The process is repeated 112 until calculation has been made for each remaining domain and the elements 111 are determined for the remaining domain in results 102. A check 113 is performed to determine whether the total number of elements equals the total number of domains that remained after check 107. Check 114 determines whether the total elements are odd or even.

If the total element is an odd number, a calculation 115 is performed to determine the middle number and calculate the median. In mathematic, the median is the middle of a distribution, which is when half the scores are above the median and half are below the median. The median is less sensitive to extreme scores than the mean and this makes it a better measure than the mean for highly skewed distributions.

If the total element is an even number, a calculation 116 is performed to determine the two middle numbers and calculate the median.

The median is then returned 117 to the user as the average rate of link growth for the search term.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

What is claimed is:

1. A method for calculating average link growth of a domain, comprising:
Selecting a search term;
Searching the search term from a data source to request results with the search term;
Obtaining a link count for each domain returned in the results retrieved from the data source;
Obtaining additional information for each domain returned in the search results;
Repeating the above process for each data source searched such that the link counts and the additional information for each domain retrieved in the search result is obtained.

2. The method of claim 1, wherein the search term is a keyword.

3. The method of claim 1, wherein the data source is a web search engine.

4. The method of claim 1, wherein the additional information retrieved is a date of creation of each domain retrieved from the data source.

5. The method of claim 4, wherein a check is made to determine whether the create date and link counts are available for each domain returned in the search results and removing domains that does not contain a create date or link counts.

6. The method of claim 5, wherein age of the domains are calculated by subtracting the create date from the date of the search.

7. The method of claim 6, wherein an element, which contains the average amount of links a domain has acquired over a lifetime of the domain, is obtained by dividing the number of links for each domain by the age of the domain.

8. The method of claim 7, wherein a check is made to determine whether a total number of elements calculated is equal to the number of domains that contain both a link count and creation date.

9. The method of claim 8, wherein the middle number for average link growth is determined and a median is calculated to obtain the average link growth for the domain when the total number of elements is odd and then displayed.

10. The method of claim 8, wherein two middle numbers for average link growth is obtained and a median number is calculated to obtain the average link growth for the domain when the total number of elements is even and then displayed.

11. A method for calculating the average length growth of a domain, comprising the steps of:
Obtaining results based on a search of a search term;
Determining a create date for each result listed in the result;
Obtaining a link count for each domain listed in the result;
Calculating an age of each domain by subtracting the created date from date of the search for each domain in the result;
Calculating an element for each result by dividing the link count of each result by the age of the domain;
Determining a median element when the element for each result on the search result has been obtained.

12. A method of claim 11, wherein the search is performed through a data source.

13. A method of claim 12, wherein the data source is a web search engine.

14. A method of claim 11, wherein the search term is a keyword.

15. A method of claim 11, wherein domain in the result without a link count is removed from calculation.

16. A method of claim 11, wherein domain in the result that does not have create date is removed from calculation.

17. A method of claim 11, wherein a check is performed to determine whether the number of elements returned is equal to the number of domains remaining on the results list.

18. A method of claim 11, wherein the average length growth of the domain is determined by taking the middle element for all of the element obtained and calculating the median when the number of elements is odd.

19. A method of claim 11, wherein the average length growth of the domain is determined by taking the two middle element for all of the element obtained and calculating the median when the number of elements is even.

20. A program using the method of the present invention for determining the average link growth of a domain.
